(19) United States
(12) Patent Application Publication
(10) Pub. No.: US 2026/0310952 A1
(43) Pub. Date: Oct. 8, 2026

(54) INFORMATION PROCESSING DEVICE, INFORMATION PROCESSING METHOD, AND PROGRAM

(71) Applicant: KYUSHU INSTITUTE OF TECHNOLOGY, Fukuoka (JP)

(72) Inventors: Kanta YOSHIOKA, Fukuoka (JP); Hakaru Tamukoh, Fukuoka (JP)

(21) Appl. No.: 19/682,775

(22) Filed: May 20, 2026

Related U.S. Application Data
(63) Continuation of application No. PCT/JP2024/040861, filed on Nov. 18, 2024.

(30) Foreign Application Priority Data
Nov. 21, 2023 (JP) 2023-197417

(51) Int. Cl. G06N 3/06; G06N 3/0442

(52) U.S. Cl. CPC G06N 3/061; G06N 3/0442

(57) ABSTRACT

Provided are an information processing device, an information processing method, and a program that can achieve three aspects of computation precision, computation speed, and circuit scale. An information processing device includes a reservoir that is provided between an input layer including one or more nodes and an output layer, the reservoir including storage means in which an input-output relation is stored, the input-output relation allowing an output value to be uniquely determined based on information that is input from the nodes of the input layer, the output value being output to the output layer. It is preferable that the storage means be realized by one or more LUTs on an FPGA, and it is more preferable that one node constituting the reservoir be realized by one LUT.

### CROSS-REFERENCE TO RELATED APPLICATIONS

This application is a Continuation Application of PCT/JP2024/040861, filed on Nov. 18, 2024, which is based upon and claims the benefit of priority from Japanese Patent Application No. JP2023-197417, filed on Nov. 21, 2023, the disclosures of which are hereby incorporated by reference herein in their entireties.

### TECHNICAL FIELD

The present invention relates to an information processing device, and particularly relates to a reservoir computing device. Further, the present invention relates to an information processing method, and particularly relates to an information processing method in which a reservoir computing device is used. Furthermore, the present invention relates to a program for causing a computer to operate as an information processing device.

### BACKGROUND ART

Conventionally, there is known a neural network (NN) that imitates the function and structure of nerve cells of the human brain. Further, there is known a recurrent neural network (RNN) having such a structure that a signal goes back in a network (an output on a certain layer is retrospectively input).

Furthermore, as a kind of the RNN, reservoir computing (RC) is known. RC is an AI technology that has received attention in recent years, and has been applied to real-time data processing. By implementing RC on an FPGA (Field Programmable Gate Array), a high-speed and low-power system can be realized.

As literatures about RC, there are Non Patent Literatures 1 to 6.

### CITATION LIST

### Non Patent Literature

Non Patent Literature 1: Kawashima, Y. Katori, T. Morie, and H. Tamukoh, “An area-efficient multiply-accumulation architecture and implementations for time-domain neural processing,” in 2021 International Conference on Field-Programmable Technology (ICFPT). IEEE, pp. 1-4, 2021.
Non Patent Literature 2: K. Yoshida, Y. Abe, M. Akai-Kasaya, and T. Asai, “FPGA Architecture for Reservoir Computing with time-division input interfaces and online learning systems,” IEICE Technical Report; IEICE Tech. Rep., 2021.
Non Patent Literature 3: Herbert Jaeger, “Tutorial on training recurrent neural networks, covering BPPT, RTRL, EKF and the “echo state network” approach”, GMD-Forschungszentrum Informationstechnik, 2002.
Non Patent Literature 4: Miquel L. Alomar, Vincent Canals, Nicolas Perez-Mora, Victor Martinez-Moll, Josep L. Rossello, “FPGA-Based Stochastic Echo State Networks for Time-Series Forecasting”, Computational Intelligence and Neuroscience, 2016.
Non Patent Literature 5: Ichiro Kawashima, Yuichi Katori, Takashi Morie, Hakaru Tamukoh, “An area-efficient multiply-accumulation architecture and implementations for time-domain neural processing”, 2021 International Conference on Field-Programmable Technology (ICFPT), pp. 1-4, Online, December 6-10 (9), 2021.
Non Patent Literature 6: Victor M. Gan, Yibin Liang, Lianjun Li, Lingjia Liu, Yang Yi, “A Cost-Efficient Digital ESN Architecture on FPGA for OFDM Symbol Detection”, ACM Journal on Emerging Technologies in Computing Systems, Volume 17, Issue 4, Article No. 47, pp. 1-15, 2021.

### SUMMARY OF INVENTION

### Technical Problem

As can be seen from Non Patent Literatures 1 to 6, in RC, the calculation amount and circuit scale in a reservoir are dominant (see Non Patent Literature 1).

Therefore, as an FPGA implementation technique for RC, time division of the computation in the reservoir has been proposed (see Non Patent Literature 2). In this technique, only a small number of arithmetic circuits are implemented on the FPGA, and they are repeatedly used while data is changed, so that the computation in the reservoir is realized. That is, the circuit scale is reduced by decreasing the number of arithmetic circuits that are implemented on the FPGA. However, this technique has a problem of a significant increase in computation time.

Meanwhile, a technique of quantizing the computation in the reservoir has also been proposed (see Non Patent Literature 4). In this technique, the weight or activity value of each reservoir neuron is quantized, and thereby, the necessary circuit scale per arithmetic circuit is reduced. Therefore. although the reduction in circuit scale can be realized, there is still a problem of the decrease in computation precision.

FPGA implementation techniques in which both of these two techniques are concurrently introduced have also been proposed (Non Patent Literatures 5 and 6). However, because of the above-described problems, it can be said that it is difficult to simultaneously achieve all three of computation precision, computation speed, and circuit scale in conventional FPGA implementation techniques for reservoir computing.

Consequently, the present invention has an object to provide an information processing device, an information processing method, and a program that can simultaneously achieve all three of computation precision, computation speed, and circuit scale.

### Solution to Problem

An information processing device in the present invention includes a reservoir that is provided between an input layer including one or more nodes and an output layer, the reservoir including storage means in which an input-output relation is stored, the input-output relation allowing an output value to be uniquely determined based on information that is input from the nodes of the input layer, the output value being output to the output layer.

In short, the information processing device of the present invention includes a reservoir that is provided between an input layer including one or more nodes and an output layer, the reservoir including storage means in which an input-output relation is stored, the input-output relation allowing an output value to be uniquely determined based on information that is input from the nodes of the input layer, the output value being output to the output layer, in the storage means, an output value calculated based on a combination of all input values that are input to neurons of the reservoir being stored in an address corresponding to the combination of the input values in a memory region of the storage means, and at the time of execution, the output value stored in the address being referred to by the combination of the input values that are input to the neurons of the reservoir being read as the address in the memory region of the storage means.

Thereby, the computation in the reservoir is finished simply by determining the output corresponding to the input in accordance with the input-output relation stored in the storage means.

It is preferable that the storage means be realized by one or more LUTs on an FPGA, and it is more preferable that one node constituting the reservoir be realized by one LUT.

It is further preferable that when the number of connections of one node constituting the reservoir is k, values corresponding to the number of combinations j (=2^{k}) of the number of connections k be stored as the output value in memories Zᵢ (i=0 to j−1) of the LUT, respectively.

Furthermore, it is preferable that a difference computation technique be used as a computation technique in the output layer, the difference computation technique being a technique of calculating only output values from nodes in which a state has changed among nodes constituting the reservoir, and it is more preferable that in the difference computation technique, when a node in which the state has changed is detected among the nodes constituting the reservoir, a state at a certain time and states at a plurality of times before the certain time be compared, and calculation be started from a state having a smallest difference.

Meanwhile, an information processing method in the present invention includes: a step of providing a reservoir between an input layer including one or more nodes and an output layer; a step of storing an input-output relation in storage means, the input-output relation allowing an output value to be uniquely determined based on information that is input from the nodes of the input layer, the output value being output to the output layer; and a step of outputting, to the output layer, an output value that is uniquely determined by the reservoir referring to the storage means based on input data from the input layer.

A program in the present invention is a program for causing a computer to operate as an information processing device including a reservoir that is provided between an input layer including one or more nodes and an output layer, the reservoir including storage means in which an input-output relation is stored, the input-output relation allowing an output value to be uniquely determined based on information that is input from the nodes of the input layer, the output value being output to the output layer.

### Advantageous Effects of Invention

According to the information processing device in the present invention, the computation in the reservoir is finished simply by determining the output corresponding to the input in accordance with the input-output relation stored in the storage means, and thereby, it is possible to provide the information processing device that can simultaneously achieve all three of computation precision, computation speed, and circuit scale.

Further, according to the information processing method and program in the present invention, it is possible to exert an equivalent function effect to that of the information processing device in the present invention.

### BRIEF DESCRIPTION OF DRAWINGS

FIG. 1 is a diagram showing an example of a typical reservoir computing model.

FIG. 2 is a diagram showing a computation example in a 3-input 1-output LUT.

FIG. 3 is a diagram showing an example of a microcomputer development board (microcomputer board, target board).

FIG. 4 is a schematic diagram showing one node in a general LUT-Network.

FIG. 5(A) is a diagram showing a configuration between an input layer and a reservoir layer in FIG. 1 and is a schematic diagram of a node of the reservoir layer to which information is input from the input layer, and FIG. 5(B) is a configuration diagram of the node that is constituted by a LUT.

FIG. 6(A) is a diagram showing a configuration in the reservoir layer in FIG. 1 and is a schematic diagram of a node of the reservoir layer to which retrospective information (signal) is input from a reservoir, and FIG. 6(B) is a configuration diagram of the node that is constituted by a LUT.

FIG. 7(A) is a diagram showing a configuration between the reservoir layer and an output layer in FIG. 1 and is a schematic diagram of a node of the output layer, and FIG. 7(B) is a configuration diagram of a general node of the output layer.

FIG. 8 is a diagram showing an example of an input-output relation among neurons in the reservoir that is stored in a LUT.

FIGS. 9(A) and 9(B) are diagrams for describing the configuration of an arithmetic circuit of the output layer, in which FIG. 9(A) is a diagram for describing a general time division technique, and FIG. 9(B) is a diagram for describing a computation technique of calculating only an output value from a neuron that is of neurons constituting the reservoir and in which the state has changed.

FIG. 10 is a diagram for describing the configuration of an arithmetic circuit of the output layer, and is a diagram for describing a computation technique of calculating only an output value from a neuron that is of neurons constituting the reservoir and in which the state has changed, and comparing a state at certain time and states at a plurality of times before the certain time to start calculation from a state having the smallest difference, when the neuron that is of the neurons constituting the reservoir and in which the state has changed is detected.

FIG. 11 is a configuration diagram of an information processing device that includes the reservoir implemented on an FPGA.

FIG. 12 shows an acquired node waveform for the reservoir of a reservoir computing device in the present invention.

FIG. 13 illustrates a generation procedure of input-output relation.

### DESCRIPTION OF EMBODIMENTS

An embodiment of the present invention will be described below in detail. The following description about constituent elements is an example (representative example) of the embodiment of the present invention, and the present invention is not limited to the following content as long as the gist is not altered. Further, in the present description, a neuron and a node are synonymous, and a reservoir and a reservoir layer are synonymous.

### [Reservoir Computing]

A reservoir is suitable for a classification or prediction in which time-series data is used, and non-linearity is required for the non-linear conversion of input data (time-series data). Further, for the classification or regression of the input data (time-series data), the reservoir needs to save (short-term memory) past input data.

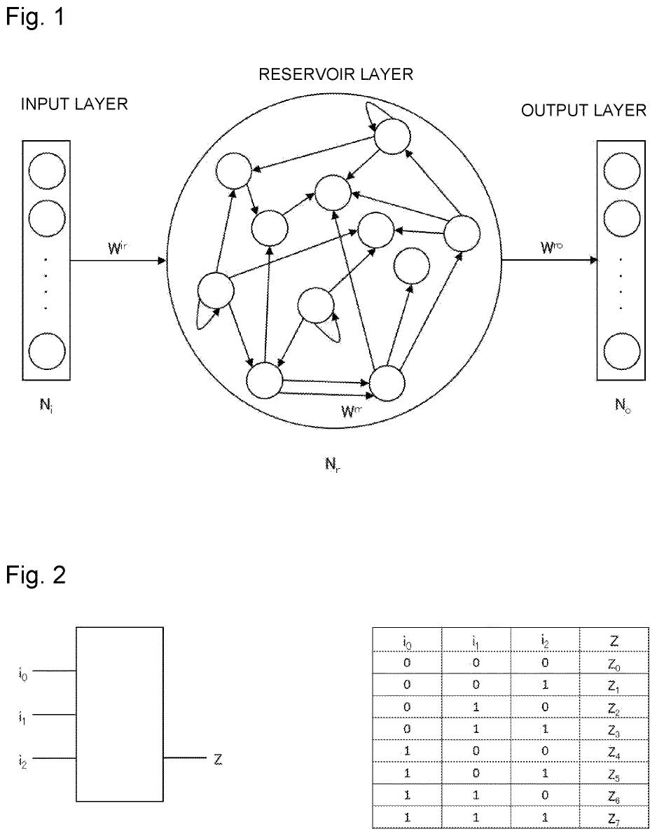

Moreover, as a reservoir computing model shown in FIG. 1, an ESN (Echo State Network), an LSM (Liquid State Machine), a CBM-RC (Chaotic Boltzmann Machine-RC), and the like are known.

Here, Nᵢ is the number of nodes of an input layer, Nᵣ is the number of nodes of the reservoir (reservoir layer), and the Nₒ is the number of nodes of an output layer. Further, W^{ir} is a load (weight) between the input layer and the reservoir, W^{rr} is a load (weight) in the reservoir, and W^{ro} is a load (weight) between the reservoir and the output layer. In reservoir computing, W^{ir} and W^{rr} are fixed by random numbers. On the other hand, W^{ro} is optimized by ridge regression or the like.

### [BNN]

As a collective term of neural networks in which a floating point is not used (binarization), BNN (Binarized Neural Networks) is known. In BNN, compared to other neural network techniques, multiplication is unnecessary, and there is an advantage in that the use amount of a memory is drastically reduced. Therefore, it can be said that BNN is suitable for FPGA implementation.

### [LUT-Network]

As a kind of BNN, a LUT-Network is known. The LUT-Network is a neural network (a neural network realized by LUTs (LUT elements) on the FPGA) that is further focused on the FPGA implementation in BNN. The LUT (Lookup Table) is a logic block that is mounted on the FPGA, and is a rewritable site.

FIG. 2(A) shows a 3-input 1-output LUT (LUT-3), and can be expressed as a truth table shown in FIG. 2(B). The table information (truth table) about the LUT is saved in an SRAM, and therefore, an arbitrary computation can be realized by rewriting the table information in the SRAM.

In a conventional reservoir implemented on the FPGA, neurons are made by adders and multipliers that are made using LUTs, and by collecting such neurons, the reservoir is constituted.

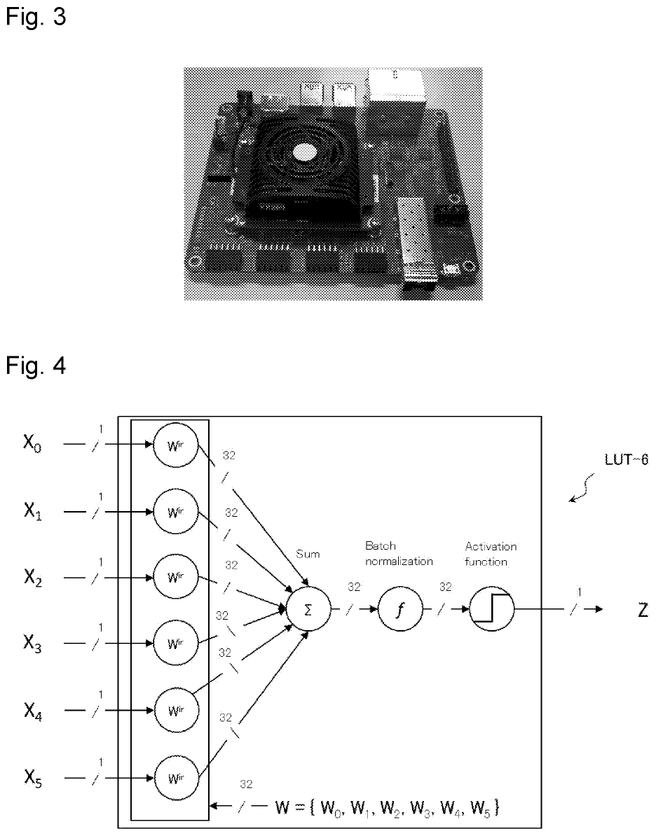

As the LUT, there are also a 4-input 1-output LUT (LUT-4), a 6-input 1-output LUT (LUT-6), and other LUTs. For example, a microcomputer development board shown in FIG. 3 is a microcomputer development board (manufacturer number: SK-KR260-G) manufactured by AMD (Advanced Micro Devices), and on this, about 100000 LUT-6s are mounted.

FIG. 4 is a schematic diagram showing one node in a typical LUT-Network, and one node is one LUT. In the example shown in FIG. 4, the LUT-6 is used, and therefore, the number of inputs to one node is 6 (X₀ to X₅) similarly to the LUT.

### [Information Processing Device in Present Invention]

### (1. Input Layer, Reservoir)

An information processing device in the present invention is a reservoir computing device including a reservoir that is provided between an input layer including one or more nodes and an output layer. The reservoir has a higher performance as the number (Nᵣ shown in FIG. 1) of nodes is larger. Further, as described above, in the reservoir computing, W^{ir} and W^{rr} are fixed, and therefore, need not be rewritten. Consequently, the inventor of the present application has conceived that an input-output relation among neurons in the reservoir is stored in storage means with no change.

Examples of the storage means include a LUT, which is employed in the embodiment, a BRAM (Block RAM), a URAM (Ultra RAM), a DRAM (Dynamic RAM), an SRAM (Static RAM), an eDRAM (Embedded DRAM), an MRAM (Magnetoresistive RAM), Flash Memory, and the like, and the storage means are not limited to these as long as the input-output relation among neurons in the reservoir can be stored.

It is known that an arbitrary circuit can be made by combining LUTs and SRAMs, but in this case, there is a disadvantage in that written data cannot be altered after circuit implementation. However, in the reservoir computing, since W^{ir} and W^{rr} are fixed, written data need not be altered after circuit implementation.

Further, connections among nodes in the neural network that is implemented on the FPGA are restricted to the number of inputs of the LUT, because the circuit scale increases in an exponential manner. However, the reservoir layer operates even in the case of sparse connections.

In view of the above, the inventor of the present application has focused particularly on the construction of the reservoir by the LUT-Network, and has conceived that the input-output relation among neurons in the reservoir is copied out (stored) in the LUT with no change.

Further, for the construction of the reservoir by the LUT-Network, the inventor of the present application has studied the reservoir computing model, based on the following conditions.
[Condition 1] The input and output can be realized by a binary (1 bit).
[Condition 2] The operation is possible even when connections are sparse.
[Condition 3] No value is held and the output is determined only by inputs and loads.

The LSM and the CBM-RC do not satisfy Condition 3 of the above Conditions 1 to 3, and it is difficult to resolve this. Therefore, in the present invention, an ESN (binary ESN) in which the input and the output are binary is employed.

More specifically, in the present invention, the binary ESN that is a most general model and that is suitable for the implementation of the LUT-Network as described above is employed as a basic model, and this is modified. The LSM (Liquid State Machine), ChNN-RC (Chaotic Neural Network Reservoir Computing), CA-RC (Cellular Automata Reservoir Computing), and the like can be employed instead of the ESN.

A brief overview of the reservoir computing device (hereinafter, a configuration of the reservoir computing device that is implemented on the FPGA is referred to as “LUTNet-RC”) in the present invention will be described. The LUTNet-RC includes an input layer including one or more nodes, a reservoir constructed by the LUT-Network, and an output layer, similarly to the typical reservoir computing model shown in FIG. 1. In the embodiment, as the LUT that is used in the reservoir, a 6-input 1-output LUT (LUT-6) is employed.

The input layer does not perform computation, and performs holding of input data, and the like.

Meanwhile, in the reservoir, an output state Sᵢ[t+1] at time t+1 is determined by a network state x[t] before 1 time and an input u(t+1) (see Expressions (1) to (3)). Here, k is the number of connections of the node of the reservoir, and since the LUT is a 6-input LUT in the embodiment, the number of connections k is 6 in accordance with that.

$$\begin{matrix}[ Expression 1 ] & \\ {x}_{i} [ t + 1 ] = sgn ( {S}_{i} ( t + 1 ] ) & Expression ( 1 )\end{matrix}$$

$$\begin{matrix}[ Expression 2 ] & \\ & Expression ( 2 )\end{matrix}$$

$${S}_{i} [ t + 1 ] = {\sum }_{j = 1}^{k} {W}_{i , j}^{rr} {x}_{j} [ t ] + {\sum }_{j = 1}^{{N}_{i}} {W}_{i , j}^{ir} {u}_{j} [ t + 1 ]$$

$$\begin{matrix}[ Expression 3 ] & \\ sgn ( x ) = \{ \begin{matrix}1 ( x > 0 ) \\ - 1 ( otherwise )\end{matrix} & Expression ( 3 )\end{matrix}$$

Further, in the output layer, based on the output from the reservoir, an output value is determined by Expression (4).

$$\begin{matrix}[ Expression 4 ] & \\ {O}_{i} [ t + 1 ] = {\sum }_{j = 1}^{{N}_{r}} {W}_{i , j}^{ro} {x}_{j} [ t + 1 ] & Expression ( 4 )\end{matrix}$$

Subsequently, the reservoir will be described in more detail. Conventionally, a node of the reservoir to which information is input from the input layer is made by an adder and a multiplier that are made using LUTs. That is, the node of the conventional reservoir outputs, to the output layer, a value resulting from performing sum-of-product computation based on the input of information from the input layer.

In such a conventional implementation technique, to realize the number of connections k, that is, the node of the reservoir having the number of inputs k, k multipliers and (k−1) adders are required. For example, in the case where the number of inputs k is 6, six multipliers and five adders are required for each node, and if this is implemented on the FPGA, typically, about several hundred LUTs are consumed for each node. Further, if the number of nodes of the reservoir increases, a use amount of the LUTs significantly increases in accordance with this, and thus, it becomes difficult to implement a large-scale reservoir.

In contrast, in the reservoir of the LUTNet-RC, an input-output relation allowing an output value to be uniquely determined based on the information input from the nodes of the input layer is stored in the LUT, the output value being output to the output layer. With this implementation technique, the sum-of-product computation itself becomes unnecessary, and the computation is completely omitted by using the combination of the input values as an address in the LUT and directly reading the output value corresponding to the address. As a result, ideally, one node can be realized with one LUT, so that it is possible to reduce the number of necessary LUTs to equal to or less than one hundredth as compared with the conventional implementation technique.

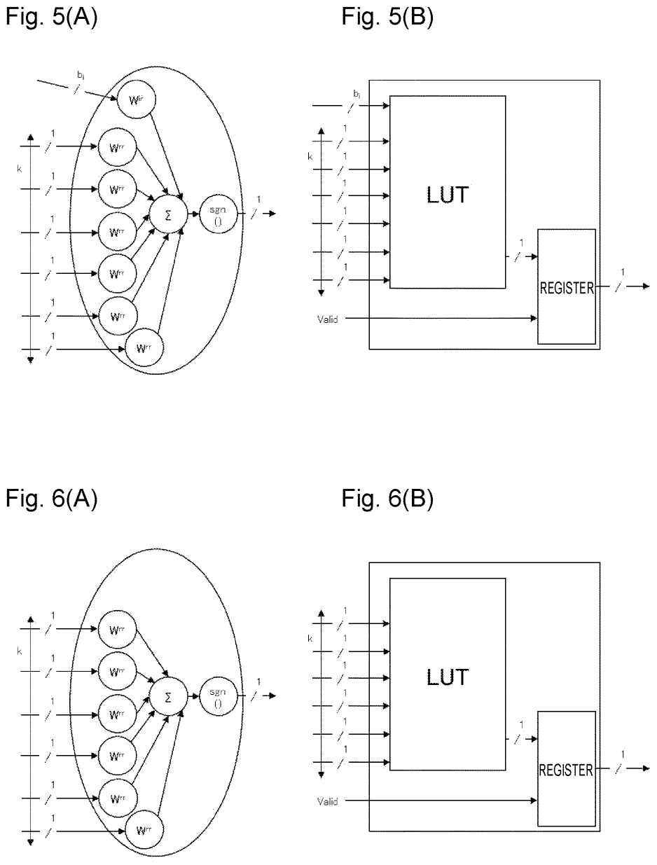

For example, as shown in FIG. 5(B), for the node of the reservoir to which information is input from the input layer, the input-output relation is stored in a bᵢ+k-input 1-output LUT. On the other hand, as shown in FIG. 6(B), for a node of the reservoir to which retrospective information (signal) is input from the reservoir, the input-output relation is stored in a k-input 1-output LUT.

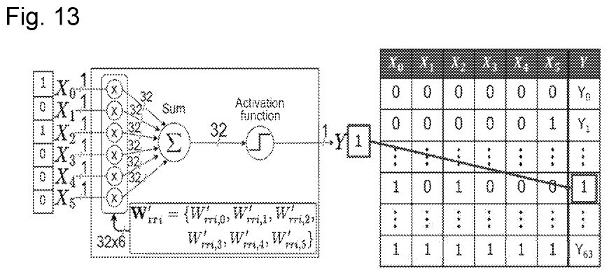

This input-output relation is generated in advance based on the reservoir models described above (Expression (1) to Expression (3)). Specifically, the input-output relation is created according to the following procedure as shown in FIG. 13.
[1] Loads W^{ir}, W^{rr} regarding the node of the reservoir are set using random numbers, or the like.
[2] The output value is calculated based on the above-described Expression (1) to Expression (3) for all possible input patterns (for example, 2\hat{ }6=64 patterns in the case where the number of inputs is 6).
[3] The calculated output value is stored in the memory region of the LUT.

By such a mapping method, the input value can be read as the address in the memory region of the LUT as is at the time of execution, so that the calculation result of the node of the reservoir can be output in one clock cycle without the computation processing being performed. Thus, while a plurality of clock cycles is required at the time of execution with the conventional implementation technique, in the present invention, only one clock cycle is required, so that it is possible to realize significant improvement in computation speed.

FIG. 8 shows an example of the input-output relation among neurons in the reservoir that is stored in the LUT. In the case where the number of connections k of the node of the reservoir is 6, the number of combinations of inputs X₀ to X₅ (0/1) is 64 (2 to the sixth power). Therefore, an output value (Z) that is output to the output layer based on information (X₀ to X₅) that is input to the neurons of the reservoir is uniquely determined by referring to the input-output relation shown in FIG. 8.

For example, in the case where the information that is input from the nodes of the input layer is X₀: 1, X₁: 0, X₂: 1, X₃: 0, X₄: 0, X₅: 0, the output value (Z) is a value (1) stored in Z₄₀ of the storage means (hereinafter, referred to as a “memory”). Needless to say, the input-output relation stored in the LUT can be referred to also in the computation in the reservoir layer.

Note that as an important point in generation of this input-output relation, it is preferable to set a value based on an arbitrary reservoir calculation model instead of simply storing random values in the memory, for the following two reasons.

First, it is known that performance of the reservoir in reservoir computing is maximized in a state called “edge of chaos”. In order that the reservoir has appropriate calculation ability, it is necessary to search for an optimal parameter using various indexes and create the input-output relation based on the parameter.

Second, in logic synthesis of the FPGA, in the case where the input-output relation has regularity, logic compression is performed, and the use amount of the LUT is reduced. The input-output relation based on the calculation model has certain mathematical regularity, and thus, benefit is easily received from the logic compression. Meanwhile, this compression effect cannot be expected in the input-output relation that is randomly generated, and in particular, in the case where bᵢ₊ₖ input is required, a circuit scale increases. Thus, in the present invention, both the performance of the reservoir and the circuit area efficiency are improved by generating the input-output relation based on an appropriate reservoir calculation model.

In this manner, by the output values in respective combinations of inputs X₀ to X₅ being stored in the specific regions (Z₀ to Z₆₃) in the memory, one neuron of the reservoir can be constituted with one LUT. This means that an equivalent function can be implemented with circuit resources equal to or less than one hundredth as compared with the conventional implementation technique. Further, by using the LUTs corresponding to the number of nodes Nᵣ of the reservoir, it is possible to constitute the reservoir having an arbitrary number of nodes.

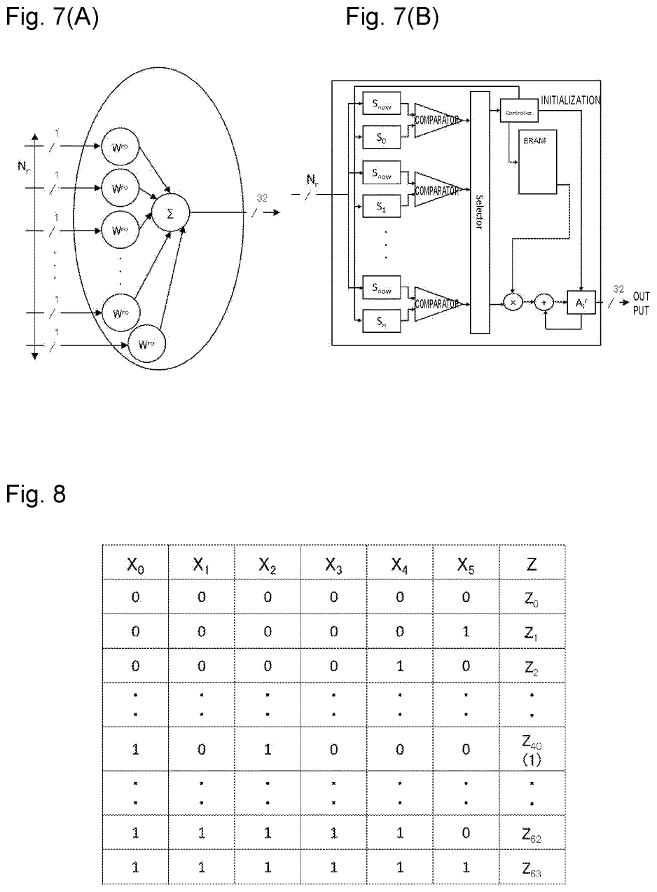

Then, the output values from the nodes of the reservoir constituted with the LUTs are transmitted to the output layers corresponding to the number of nodes Nᵣ, and a result of the sum-of-product computation is output (see FIG. 7). With this implementation technique, all the computation in the reservoir layer can be replaced with reading from the memory, so that it is possible to simultaneously meet a plurality of requirements of reduction in circuit scale and improvement in computation speed, which contradict each other, while securing computation precision.

### (2. Output Layer)

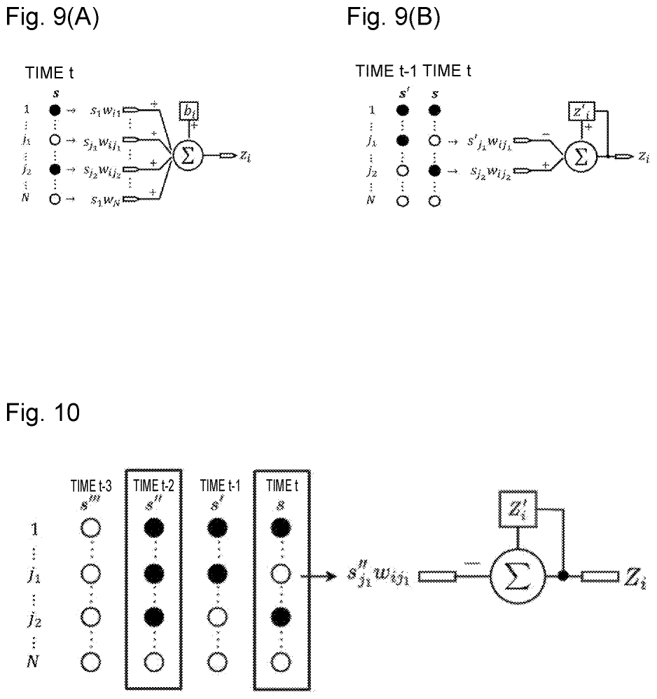

It is possible that a general time division technique shown in FIG. 9(A) is employed in the circuit configuration of the output layer. In this technique, the output values from all neurons of the reservoir at time t are calculated. However, since the output values of all neurons are calculated, the calculation time increases in proportion to the number of neurons. That is, in this technique, there is a fear that a sufficient computation speed cannot be obtained when the number of neurons of the reservoir is large.

Therefore, as shown in FIG. 9(B), it is possible that a computation technique (this technique is referred to as “difference computation technique”) of calculating only the output values from neurons that are of the neurons constituting the reservoir and in each of which the state has changed is employed in the circuit configuration of the output layer. For example, in the example shown in FIG. 9(B), only the output values from j₁-th and j₂-th neurons in each of which the state has changed are calculated, and the difference from a last input value z′ᵢ is calculated.

In the difference computation technique, even when the number of neurons of the reservoir is large, a sufficient computation speed can be obtained compared to the general time division technique. However, in the difference computation technique, to a state at a certain time (t), only a state before 1 time (t−1) is compared. Therefore, the difference computation technique is effective when the number of neurons in each of which the state has changed is small. However, when the number of neurons in each of which the state has changed is large, there is a fear that the calculation time increases and a sufficient calculation speed cannot be obtained.

Consequently, the inventor of the present application has conceived a technique of comparing a state at a certain time and states at a plurality of times before the certain time and starting calculation from a state having the smallest difference, when neurons that are of the neurons constituting the reservoir and in each of which the state has changed are detected in the difference computation technique. In this technique (hereinafter, referred to as “multi-difference computation technique”), as exemplified in FIG. 10, a state at a certain time (t) and states at a plurality of times (t−1 to t−3) before the certain time are compared, and calculation is started from a state (j₁-th neuron) having the smallest difference.

According to the multi-difference computation technique, in addition to the case where the number of neurons in each of which the state has changed is small, even in the case where the number of neurons in each of which the state has changed is large, the increase in calculation time can be restrained, and therefore, a sufficient computation speed can be obtained.

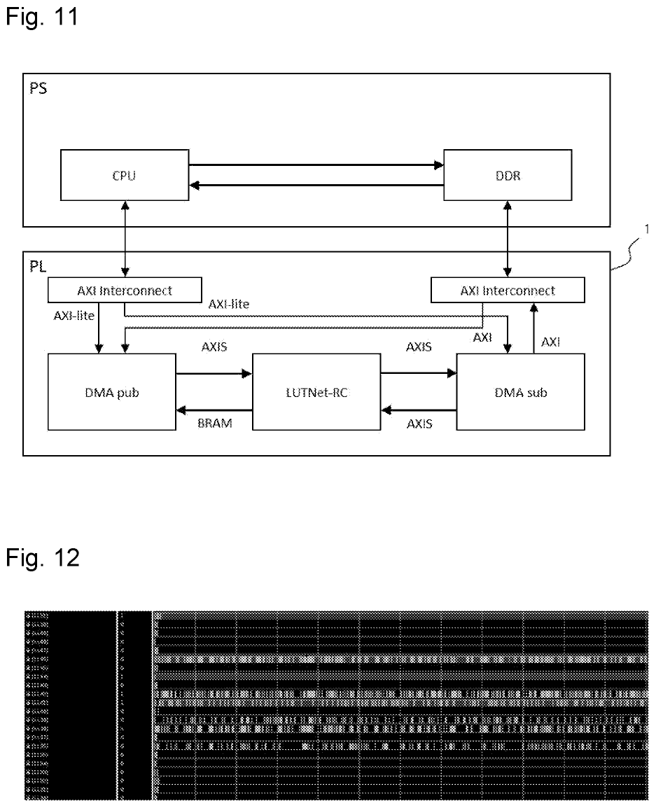

Further, the information processing device (reservoir computing device) 1 in the present invention can be constructed by implementing the LUTNet-RC on the FPGA of a PL (Programmable Logic), as shown in FIG. 11.

### Example

A result of an experiment in which the reservoir computing device 1 in the embodiment was used as an example is shown below. In the LUTNet-RC of the reservoir computing device 1 in the example, the number of nodes Nᵣ of the reservoir layer was 1500, and the whole circuit scale is shown in Tables 1 to 3.

Table 1 is a table showing the circuit scales of the input layer and the reservoir layer, and shows the numbers of LUTs and FFs for each bit precision of the input. Further, Table 2 is a table showing the circuit scale of the output layer, and shows the numbers of LUTs, FFs, and BRAMs for each of the above-described circuit configurations (the time division technique, the difference computation technique, and the multi-difference computation technique) of the output layer.

Speed increase rate shown in Table 2 is an index indicating how much the speed could be increased compared to the time division technique, and indicates a result of the simulation on software in a state at the time of NARMA 10 input. For example, it is found that the use of the difference computation technique for the output layer could realize an 18 times higher speed compared to the time division technique. On the other hand, it is found that the use of the multi-difference computation technique (see four states at t, t−1, t−2, and t−3) for the output layer could realize a 25 times higher speed compared to the time division technique.

Table 3 is a table showing the circuit scale including the input layer, the reservoir layer, and the output layer, and the numbers of LUTs and FFs are sums of values shown in Tables 1 and 2. The bit precision of the input in Table 3 is 10.

TABLE 1

| Bit precision | | |
|---|---|---|
| of input | LUT | FF |
| 6 | 1,490 | 1,470 |
| 8 | 1,490 | 1,470 |
| 10 | 1,490 | 1,470 |
| 12 | 1,490 | 1,470 |

TABLE 2

| | | | | Speed |
|---|---|---|---|---|
| | | | | increase |
| HW-oriented algorithm | LUT | FF | BRAM | rate |
| Time division technique | 452 | 1,592 | 1 | ×1.0 |
| Difference sum-of- | 10,994 | 4,645 | 1 | ×18.0 |
| product computation | | | | |
| Multi-difference sum-of- | 23,037 | 9,175 | 1 | ×25.0 |
| product computation | | | | |

TABLE 3

| HW-oriented algorithm | LUT | FF | DSP | BRAM |
|---|---|---|---|---|
| Time division technique | 1,942 | 3,062 | 0 | 1 |
| Difference sum-of- | 12,484 | 6,115 | 0 | 1 |
| product computation | | | | |
| Multi-difference sum-of- | 24,527 | 10,645 | 0 | 1 |
| product computation | | | | |

### [Computation Precision]

Table 4 shows comparison results about the computation precision between the LUTNet-RC and conventional techniques. Conventional Techniques 1 to 10 are technologies described in the following reference literatures.
(Conventional Technique 1) V. M. Gan, Y. Liang, L. Li, L. Liu, and Y. Yi, “A cost-efficient digital esn architecture on fpga for ofdm symbol detection,” ACM Journal on Emerging Technologies in Computing Systems (JETC), vol. 17, no. 4, pp. 1-15, 2021.
(Conventional Technique 2) C. Lin, Y. Liang, and Y. Yi, “Fpga-based reservoir computing with optimized reservoir node architecture,” in 2022 23rd International Symposium on Quality Electronic Design (ISQED). IEEE, 2022, pp. 1-6.
(Conventional Technique 3) K. Honda and H. Tamukoh, “A hardware-oriented echo state network and its fpga implementation,” Journal of Robotics, Networking and Artificial Life, vol. 7, no. 1, pp. 58-62, 2020.
(Conventional Technique 4) D. Kleyko, E. P. Frady, M. Kheffache, and E. Osipov, “Integer echo state networks: Efficient reservoir computing for digital hardware,” IEEE Transactions on Neural Networks and Learning Systems, vol. 33, no. 4, pp. 1688-1701, 2020.
(Conventional Technique 5) M. L. Alomar, V. Canals, N. Perez-Mora, V. Martinez-Moll, and J. L. Rossello, “Fpga-based stochastic echo state networks for time-series forecasting,” Computational intelligence and neuroscience, vol. 2016, pp. 15-15, 2016.
(Conventional Technique 6) K. Yoshida, Y. Abe, M. Akai-Kasaya, and T. Asai, “Fpga architecture for reservoir computing with time-division input interfaces and online learning systems,” IEICE Technical Report; IEICE Tech. Rep., 2021.
(Conventional Technique 7) B. Penkovsky, L. Larger, and D. Brunner, “Efficient design of hardware-enabled reservoir computing in fpgas,” Journal of Applied Physics, vol. 124, no. 16, 2018.
(Conventional Technique 8) B. Schrauwen, M. D'Haene, D. Verstraeten, and J. Van Campenhout, “Compact hardware liquid state machines on fpga for real-time speech recognition,” Neural networks, vol. 21, no. 2-3, pp. 511-523, 2008.
(Conventional Technique 9) I. Kawashima, Y. Katori, T. Morie, and H. Tamukoh, “An area-efficient multiply-accumulation architecture and implementations for time-domain neural processing,” in 2021 International Conference on Field-Programmable Technology (ICFPT). IEEE, 2021, pp. 1-4.
(Conventional Technique 10) D. Pramanta and H. Tamukoh, “Fpga implementation of pulse-coupled phase oscillators working as a reservoir at the edge of chaos,” in 2021 IEEE International Symposium on Circuits and Systems (ISCAS). IEEE, 2021, pp. 1-5.

TABLE 4

| | | RC | Accuracy | |
|---|---|---|---|---|
| Object | | type | Nᵣ | NRAMA10 |
| LUTNet- | — | ESN | 1,500 | MSE = 0.00282 |
| RC | Time division | | | NMSE = 0.01769 |
| | technique | | | RMSE = 0.05306 |
| | Difference | | | NRMSE = 0.13721 |
| | computation | | | |
| | technique | | | |
| | Multi-difference | | | |
| | computation | | | |
| | technique | | | |

| Conventional Technique 1 | | 100 | NMSE = 0.1250 |
|---|---|---|---|
| Conventional Technique 2 | | — | — |
| Conventional Technique 3 | | 600 | MSE = 0.030 |
| Conventional Technique 4 | | — | — |
| Conventional Technique 5 | | — | — |
| Conventional Technique 6 | ESN | 400 | NRMSE = 0.159 |
| Conventional Technique 7 | (virtual) | — | — |
| Conventional Technique 8 | LSM | — | — |
| | (virtual) | | |
| Conventional Technique 9 | CBM- | 1,500 | NMSE = 0.040 |
| | RC | | |
| Conventional Technique 10 | PCPO- | 100 | RMSE = 0.249 |
| | RC(*) | | |

(*)pulse-coupled phase oscillators-RC

From the comparison results, it is found that the LUTNet-RC was smaller in MSE (mean square error) and the like than the conventional techniques in a benchmark task (NARMA10) and had the highest precision.

### [Computation Speed]

Table 5 shows comparison results about the computation speed between the LUTNet-RC and the conventional techniques. Conventional Techniques 1 to 10 have been described above.

TABLE 5

| | | | Speed | |
|---|---|---|---|---|
| Object | | RC type | Nᵣ | throughput |
| LUTNet-RC | — | ESN | 1,500 | 0.067Msps |
| | Time division | | | |
| | technique | | | |
| | Difference | | | 1.2Msps |
| | computation | | | |
| | technique | | | |
| | Multi-difference | | | 1.7Msps |
| | computation | | | |
| | technique | | | |

| Conventional Technique 1 | | 32 | 2.6Msps |
|---|---|---|---|
| Conventional Technique 2 | | 16 | 1.2Msps |
| Conventional Technique 3 | | 100 | 0.20Msps |
| Conventional Technique 4 | | 300 | 0.035Msps |
| Conventional Technique 5 | | 50 | 25Msps |
| Conventional Technique 6 | ESN | 400 | 1.2Msps |
| Conventional Technique 7 | (virtual) | 18 | 0.31Msps |
| Conventional Technique 8 | LSM | 200 | 0.024Msps |
| | (virtual) | | |
| Conventional Technique 9 | CBM-RC | 1,500 | 0.033Msps |
| Conventional Technique 10 | PCPO-RC | 100 | 0.23Msps |

With reference to Table 5, there are conventional techniques (for example, Conventional Technique 1 and Conventional Technique 5) that have higher throughputs than the LUTNet-RC. This is because that the numbers of nodes of the reservoir layers were only 32 and 50.

Therefore, by matching the numbers of nodes in Conventional Techniques 1 and 5 with that (1500) in the LUTNet-RC or with 100 nodes, which is an experiment condition for the benchmark task (NARMA10), the calculation times in the reservoir layers increase, and thereby, the throughputs in Conventional Techniques 1 and 5 significantly decrease.

Despite such a fact, in the reservoir layer of the LUTNet-RC, the input-output relation allowing the output value that is output to the output layer, to be uniquely determined based on information that is input from the nodes of the input layer is stored in the LUT, and therefore, simply by reading it (that is, in one clock), the calculation is finished.

Therefore, it can be said that the computation speed in the reservoir layer of the LUTNet-RC can be increased to the utmost limit, and furthermore, it can be said that a further increase in the computation speed can be realized depending on the circuit configuration of the output layer. This is obvious also from the fact that the throughputs when the difference computation technique and the multi-different computation technique were employed in the circuit configuration of the output layer were significantly enhanced compared to the throughput when they were not employed.

FIG. 12 shows a node waveform for the reservoir of the LUTNet-RC. From this waveform, it can be said that the frequency of the regular inversion of the output of the neuron was high. That is, it can be said that the number of neurons in each of which the state changed was large. Therefore, in the LUTNet-RC, it is thought to be preferable that the multi-difference computation technique be employed for the output layer rather than the difference computation technique.

In short, in the LUTNet-RC, it is possible to finish the calculation in the reservoir layer in one clock, to improve the high frequency (the number of neurons in each of which the state has changed is large) of the regular inversion of the output of the neuron of the reservoir layer, by the devisal of the output layer, and to obtain a sufficient computation speed.

The reason why the frequency of the regular inversion of the output of the neuron of the reservoir of the LUTNet-RC was high as shown in FIG. 12 is thought to be the binarization of the output of the neuron. That is, it is thought that a subtle change in the calculation value in the reservoir was rounded to 0 or 1 by a binarization activation function.

As another application example, since the use of the multi-difference computation technique for the output layer can realize at least a 25 times higher speed compared to the time division technique, an inference in the order of Mfps is possible.

### [Circuit Scale]

Table 6 shows comparison results about the circuit scale between the LUTNet-RC and the conventional techniques. Conventional Techniques 1 to 10 have been described above.

The reason why the circuit scale (LUT, FF, DSP, and BRAM) of the LUTNet-RC in Table 6 partially increases compared to that shown in Table 3 is because Table 6 shows the circuit scale of the whole system on the PL shown in FIG. 11 and also includes a communication circuit for the PS (for example, about 5000 LUTs are used for a DMA pub and a DMA sub).

TABLE 6

| | | | Circuit resources | | | | | |
|---|---|---|---|---|---|---|---|---|
| | | RC | | | Utilization | | | |
| Object | | type | module | Nᵣ | LUT | FF | DSP | BRAM |
| LUTNet- | — | ESN | RC | 1,500 | 6,945 | 12,209 | 0 | 4 |
| RC | Time | | | | | | | |
| | division | | | | | | | |
| | technique | | | | | | | |
| | Difference | | | | 17,901 | 15,247 | 0 | 4 |
| | computation | | | | | | | |
| | technique | | | | | | | |
| | Multi- | | | | 30,549 | 19,681 | 0 | 4 |
| | difference | | | | | | | |
| | computation | | | | | | | |
| | technique | | | | | | | |

| Conventional Technique 1 | | | 16 | 10,967 | 7,203 | 162 | 12 |
|---|---|---|---|---|---|---|---|
| Conventional Technique 2 | | | 16 | 2,133 | 5,978 | 16 | 0 |
| Conventional Technique 3 | | | 100 | 28,933 | 44,021 | 20 | 48 |
| Conventional Technique 4 | | | 300 | 4,071 | 5,497 | 6 | 12.5 |
| Conventional Technique 5 | | | 50 | 5,306 Logic elements | | | |
| Conventional Technique 6 | ESN | RC + | 400 | (CycloneIV EP4CE10F17C8) | | | |
| | (virtual) | trainer | | | | | |
| Conventional Technique 7 | | | 18 | (Virtex6: 7% of LUTs and 77% of BRAMs) | | | |
| Conventional Technique 8 | LSM | RC | 200 | 10,118 | — | 103 | 30 |
| | (virtual) | | | | | | |
| Conventional Technique 9 | CBM- | | 2,048 | 1,089,461 | 593,285 | 2,048 | 1 + 256 |
| | RC | | | | | | |
| Conventional Technique 10 | PCPO- | reservoir | 100 | 2,283 | 1,695 | 0 | 0 |
| | RC | | | | | | |

From the comparison results, it is found that the circuit scale of the LUTNet-RC was about 1/10 to 1/100 of the circuit scales in the conventional techniques as the ratio of the number of nodes (when the comparison was performed while the number of nodes in each conventional technique was regarded as 1500). That is, it can be said that the LUTNet-RC had a sufficient performance (the computation precision and the computation speed) as described above and could realize a significant reduction in the circuit scale, and therefore, it can be said that the LUTNet-RC can be implemented in an edge device that requires a high performance (the computation precision and the computation speed).

From the above example, it can be said that the information processing device (LUTNet-RC) in the present invention can simultaneously achieve all three of computation precision, computation speed, and circuit scale.

The information processing device (LUTNet-RC) described above is just one example of the embodiment, and the design can be altered when appropriate, as long as the gist is not altered.

For example, as the method for constructing the LUTNet-RC, an arbitrary technique can be employed. Specifically, for the input layer and the reservoir layer, it is possible to generate circuit configurations (programs) that are stored in the FPGA, using Python.

For the output layer, it is possible to generate a circuit in which a hardware-oriented algorithm is introduced, using Verilog,

In addition, in the present description, values that are stored in the memory are binary data (0 or 1), but needless to say, the information and output value that are input from the nodes of the input layer are not limited to this.

### INDUSTRIAL APPLICABILITY

The present invention relates to the information processing device, information processing method, and program that can simultaneously achieve all three of computation precision, computation speed, and circuit scale, can be implemented also in a small-sized device, particularly, and therefore, is industrially useful.

### REFERENCE SIGNS LIST

1 information processing device (reservoir computing device)

1. An information processing device comprising a reservoir that is provided between an input layer including one or more nodes and an output layer,
the reservoir including storage means in which an input-output relation is stored, the input-output relation allowing an output value to be uniquely determined based on information that is input from the nodes of the input layer, the output value being output to the output layer,
in the storage means, an output value calculated based on a combination of all input values that are input to neurons of the reservoir being stored in an address corresponding to the combination of the input values in a memory region of the storage means, and
at the time of execution, the output value stored in the address being referred to by the combination of the input values that are input to the neurons of the reservoir being read as the address in the memory region of the storage means.

2. An information processing device comprising a reservoir that is provided between an input layer including one or more nodes and an output layer,
the reservoir including storage means in which an input-output relation is stored, the input-output relation allowing an output value to be uniquely determined based on information that is input from the nodes of the input layer, the output value being output to the output layer.

3. The information processing device according to claim 2, wherein one node constituting the reservoir is realized by one LUT.

4. The information processing device according to claim 3, wherein when the number of connections of one node constituting the reservoir is k, values corresponding to the number of combinations j (=2^{k}) of the number of connections k are stored as the output value in memories Zᵢ (i=0 to j−1) of the LUT, respectively.

5. The information processing device according to claim 1, wherein a difference computation technique is used as a computation technique in the output layer, the difference computation technique being a technique of calculating only output values from nodes in which a state has changed among nodes constituting the reservoir.

6. The information processing device according to claim 5, wherein in the difference computation technique, when a node in which the state has changed is detected among the nodes constituting the reservoir, a state at a certain time and states at a plurality of times before the certain time are compared, and calculation is started from a state having a smallest difference.

7. An information processing method comprising:
a step of providing a reservoir between an input layer including one or more nodes and an output layer;
a step of storing an input-output relation in storage means, the input-output relation allowing an output value to be uniquely determined based on information that is input from the nodes of the input layer, the output value being output to the output layer; and
a step of outputting, to the output layer, an output value that is uniquely determined by the reservoir referring to the storage means based on input data from the input layer.

8. A non-transitory computer-readable recording medium storing a program for causing a computer to operate as an information processing device comprising a reservoir that is provided between an input layer including one or more nodes and an output layer,
the reservoir including storage means in which an input-output relation is stored, the input-output relation allowing an output value to be uniquely determined based on information that is input from the nodes of the input layer, the output value being output to the output layer.
